(19) United States
(12) Patent Application Publication
(10) Pub. No.: US 2007/0267131 A1
(43) Pub. Date: Nov. 22, 2007

(54) Method of manufacturing a breast prosthesis

(76) Inventors: Paul Reitmeter, Babensham (DE); Helmut Wild, Rosenheim (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/804,395

(22) Filed: May 17, 2007

(30) Foreign Application Priority Data
May 19, 2006 (DE) 10 2006 023 675.0
Jul. 28, 2006 (DE) 10 2006 035 069.3

(51) Int. Cl. B29C 33/40; C08J 5/00; B29D 31/00; B32B 37/00; B29C 47/00

(52) U.S. Cl. 156/242; 264/219; 264/331.11; 264/236; 156/245; 156/272.8; 156/275.1

(57) ABSTRACT

The present disclosure relates to a method of manufacturing a breast prosthesis, wherein a film pouch of at least three film layers is welded for the production of at least two chambers. First, the film pouch is inserted into a prosthetic mold and the outwardly disposed chamber is filled with a mass; the mold is closed with a rear mold part having a specially defined contour and the transparent mass is cross-linked so much that it remains stable in shape in the further production steps. Subsequently, the inner chamber is filled with a second, largely light impermeable mass comprising light fillers and a mold half comprising a shallow cavity is inserted to completely cross-link the masses located in the chamber at a raised temperature.

### CROSS REFERENCE TO RELATED APPLICATION

This application claims priority to German Patent Application Serial No. DE 10 2006 023 675.0 filed on May 19, 2006, and German Patent Application Serial No. DE 10 2006 035 069.3 filed on Jul. 28, 2006, which are hereby incorporated by reference in their entirety for all purposes.

### FIELD

The present disclosure relates to a method of manufacturing a breast prosthesis which substantially comprises bodies welded in plastic films and approximating the shape of a breast.

### BACKGROUND AND SUMMARY

Breast prostheses are already known which are filled with light silicone to reduce weight. Light silicone of this type comprises a standard silicone with the addition of hollow sphere fillers to save weight. These breast prostheses are continuously gaining market share. The predominant proportion of breast prostheses are worn in special brassieres or in other particularly suitable brassieres equipped with pockets. The total weight of the prostheses must therefore be taken up by the brassiere and thus mainly by the brassiere wearer. This weight strain is in particular felt to be unpleasant in large sizes. Light prostheses having a weight saving of 25 to 35% by weight therefore increase the comfort in wear considerably and additionally show a still sufficient movement behavior.

The silicone material primarily used in breast prostheses is transparent by nature. The desired skin tone can be achieved without problem, for example by the addition of small portions of color pigments—for example an addition to the mixture of 0.2% by weight of color pigment. Polyurethane films are typically used as the films surrounding the silicone. They have a high elasticity and softness. They nevertheless tend to be stiff in comparison with the silicone used so that the film tends to form wrinkles. Due to the light permeability of the polyurethane film and of the silicone, these wrinkles are, however, not very visible and are therefore not irritating.

A white color results in the light silicone which is very opaque due to the addition of hollow sphere fillers which in turn comprise light permeable plastic. This is due to the fact that the hollow sphere fillers comprise a multiplicity of spheres which act individually as a color prism. This phenomenon is comparable, for example, with transparent snow crystals which likewise appear white in total due to refraction. The white color of the light silicone can be varied in the direction of matching to the skin tone by the addition of color pigments. This is, however, not reproduced as naturally as is possible with standard silicone. Due to these color differences, the previously mentioned wrinkles of the polyurethane film become substantially more visible due to the opaque color of the light silicone and are perceived as visually irritating.

It has already become known to avoid the aforesaid problem to provide a multilayer breast prosthesis, with a thin top coat of standard silicone being formed outwardly on the front side which is transparent and produces an appealing appearance with the color matched to the skin tone.

A method of manufacturing a multi-chamber breast prosthesis is known from EP 0 880 951 B1 in which the manufacture of the cosmetic layer takes place outside the prosthesis shape.

It is now the object of the present disclosure to develop a method to provide a prosthesis of this type with a so-called cosmetic top coat in a simple manner.

This object is solved in accordance with the present disclosure by a method In accordance with the present disclosure of manufacturing the breast prosthesis, which comprises bodies welded in plastic films and approximating the shape of a breast, comprises the following steps:

welding a film pouch of at least three film layers to produce at least two chambers;

inserting the film pouch into the prosthesis shaping tool;

filling the outwardly disposed chamber with a transparent mass preferably already cross-linked at ambient temperature or at a slightly raised temperature;

partial or complete curing of the transparent mass to achieve sufficient shape stability for the further production steps;

filling the inner chamber with a second mass, largely impermeable to light and filled with light fillers;

inserting one mold half with a shallow cavity defining the end contour (=rear mold half) to completely cross-link the masses located in the chamber at an increased temperature;

where an optional third chamber can either be filled together with the outer layer in a layer thickness of preferably 2-10 mm in the same function as the outer layer; or

it is filled together with the inner chamber in a softness and in an amount as described in the Amoena patent EP 0 320 590 (Mulligan).

Since the outer thin layer is already cross-linked at ambient temperature or at an only slightly raised temperature, the time for the manufacture of the total breast prosthesis can be substantially reduced. Overall, a simple method is produced which results in the manufacture of breast prostheses in high quality without visual defect.

Accordingly, a mold half with a deep cavity can advantageously be placed on the first mold half for the formation of the thin outer layer in the outer chamber of the film pouch so that the layer thickness of the outer layer is defined by the gap between the mold halves.

Alternatively to this embodiment of the outer layer, the so-called cosmetic layer, instead of inserting a mold half with a deep cavity, a thinner outer layer in the outer chamber can also be caused by corresponding pressure and/or vacuum which is exerted on the film pouch tensioned in the mold and comprising elastic material so that the contour of the desired cavity results. A high precision is not required in the preparation of the mold due to the procedure. In this method variant, the film pouch is also advantageously not stretched so much in the cross-linking of the outer layer.

The film layers forming the film pouch advantageously comprise polyurethane. The polyurethane film advantageously has a thickness of 40 μm to 100 μm. The polyurethane films can advantageously be welded to one another by means of thermal welding, RF welding or laser welding.

The first mass which is filled in the first chamber of the film pouch and which forms the cosmetic outer layer comprises a silicone mixture which is adjusted so that it advantageously already cross-links sufficiently strongly at room temperature and is largely stable in shape after a few minutes reaction time. A silicone mixture can also be selected which achieves these properties at comparatively low temperatures in a short time.

Color pigments are advantageously mixed in to the mass filled in the first chamber of the film pouch.

The softness of the silicone introduced in the first chamber of the film pouch amounts to between 170 and 230 units measured in penetration units after the crosslinking.

The temperature is advantageously selected for the complete cross-linking of the mass filled in the second chamber of the film pouch such that the film material is thereupon plastically deformed without permanently damaging the film. When polyurethane is used as the film material, the temperature can be set to approximately 130° C. in order to achieve a good cross-linking of the silicone and a sufficient deformation of the polyurethane film in a fast time.

In accordance with a further advantageous aspect of the present disclosure, the film pouch can be made from four film layers while forming three chambers, with the comparatively thin third chamber being arranged on the rear side of the film. This comparatively thin third chamber also represents a so-called cosmetic layer.

The first chamber can have a thickness of approximately 2 to 10 mm. The third chamber can be made either similar to the first chamber as a cosmetic layer in comparable thickness or in accordance with the soft layer as described in EP 0 320 590 (Mulligan).

### BRIEF DESCRIPTION OF THE FIGURES

Further features, details and advantages of the present disclosure will be explained with reference to an embodiment shown in the drawing. There are shown:

FIG. 1 is a schematic representation of a mold for the forming of a breast prosthesis with an inserted film pouch in which only the outer layer is filled with silicone in accordance with an intermediate step of the method in accordance with the present disclosure;

FIG. 2 is a representation in accordance with FIG. 1 in which the second chamber is also filled; and

FIG. 3 is a schematic representation of a mold for the forming of a breast prosthesis with an inserted film pouch in which only the outer layer is filled with silicone in accordance with an intermediate step with a cavity of the method in accordance with the present disclosure shaped similar to a membrane.

### DETAILED DESCRIPTION

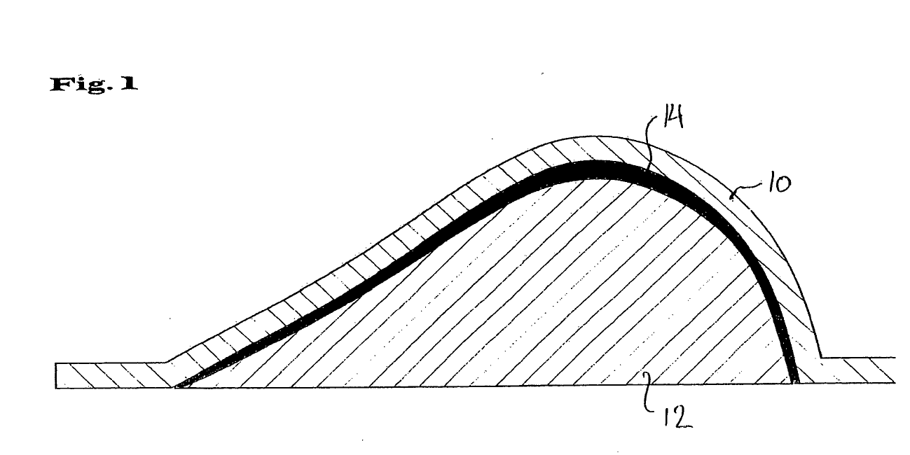

On the manufacture of the breast prosthesis in accordance with the present disclosure, a film pouch is welded first from at least three film layers. To the extent that three film layers are used, two chambers are formed. Alternatively, however, four film layers can also be welded together so that three chambers are created. The film used comprises polyurethane in a thickness of typically 40 μm to 100 μm. The welding of the film layers takes place by thermal welding, RF welding or laser welding. This film pouch is inserted into the prosthesis mold. In FIG. 1, the prosthesis mold is shown schematically. It comprises two mold halves 10 and 12. The precise design of the mold does not have to be explained here since it forms part of the prior art.

The films are initially not completely welded around the periphery so that there is still an inlet opening present here to fill in the silicone mixture. The first chamber, which is designated by 14 in FIG. 1, is filled first via the opening. A mold half 12 having a deep cavity is inserted into the mold to form the first chamber. The silicone layer contained in the first chamber is cross-linked either at room temperature or in a short furnace path, for example at 100° C., in a few minutes. The silicone used in the first chamber is formulated such that it cross-links at least so much at room temperature within a few minutes that the desired layer thickness and layer distribution is maintained in the further production steps. The cavity of the mold half 12 is configured such that only a hollow space remains free for the thin layer in this tool. The silicone in the first chamber is a silicone rubber which cross-links in an addition process without cleavage products. The softness is measured in penetration units and, in the normal case, lies between 170 and 230 units.

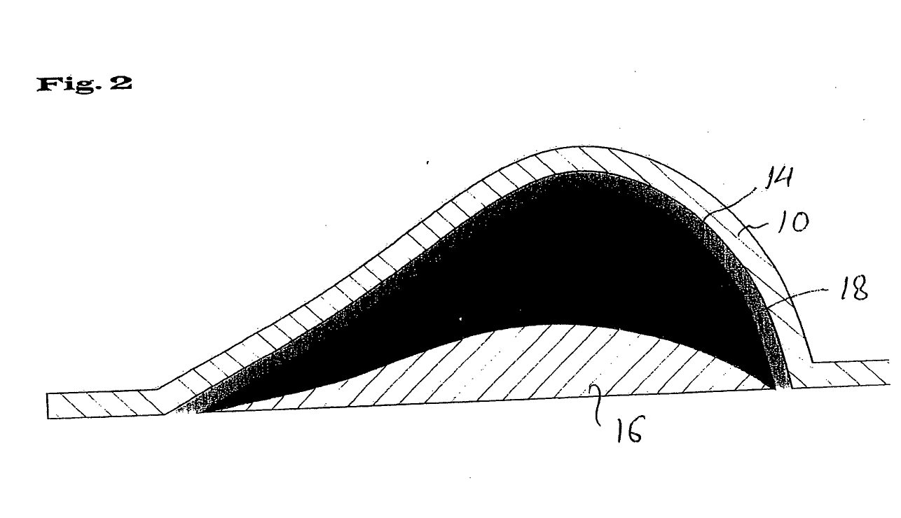

After forming an outer first silicone layer preferably having a thickness between 2 and 10 mm, the second chamber representing the main chamber is filled. Here, a light silicone, that is a mixture of silicone and hollow sphere material, is filled in. Subsequently, a new mold half, as shown in FIG. 2, namely a shallow form half 16 is placed on. This mold half is configured such that the second chamber is surrounded by the light silicone. This second chamber is designated by 18 in FIG. 2. The mold prepared in accordance with FIG. 2 subsequently runs through the main furnace process. The temperature in the furnace process is primarily based on the softening temperature and the softening times of the polyurethane film forming the pouch. The temperature is set such that a permanent plastic deformation is achieved in the polyurethane film; however, without the film being thermally damaged. Film temperatures of approx. 130° C. are usually set here.

After this production step, the prosthesis is taken out of the mold and the overhanging film is cut off, for example with a sharp knife, scissors or a stamping tool.

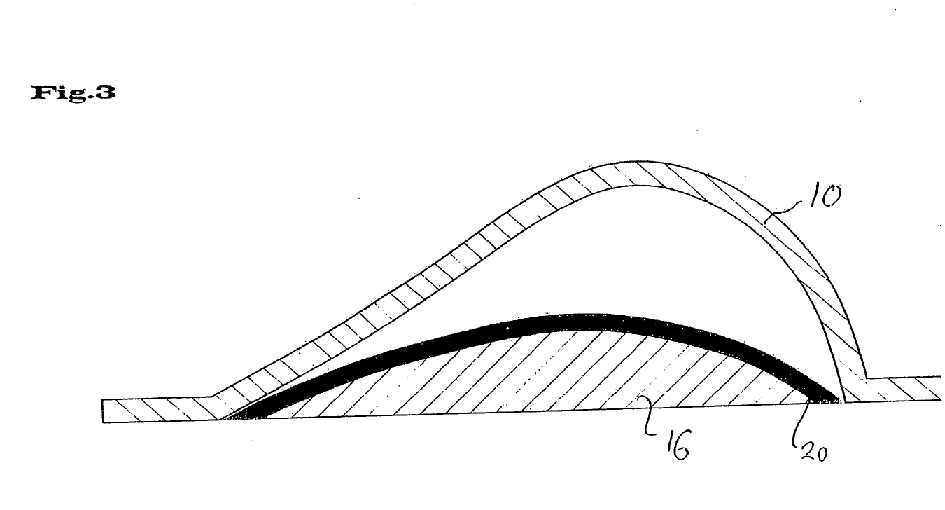

An alternative procedure is shown in FIG. 3. A membrane-like cavity 20 is present here whose shape is similar to a film layer which was deformed by vacuum or air pressure. The method used here substantially corresponds to the previously described method. It proves to be problematic in the previously described method to maintain the vacuum with high precision. This is made more difficult when the film layers become softer due to heating. The use of the membrane-like cavity makes it possible to maintain the contour in a defined state.

The present method has the advantage with respect to the manufacturing process using a deep cavity that the filling volume can be varied. The membrane-like cavity also does not have to be made so precisely as with a deep cavity. However, the mold must be positioned horizontally until the first layer has been sufficiently fully vulcanized.

It is also possible with the process to produce a third chamber on the side facing the body. The third chamber can be filled close in time to the first, outer chamber and can be fully vulcanized, at least in part, together or can be produced in two separate filling and vulcanization steps. Subsequently, the middle chamber is filled with light silicone and is fully vulcanized.

The third chamber can, however, also be configured as an extremely soft layer as described in EP 0 320 590 (Mulligan). Either the middle chamber is filled with light silicone and the rear chamber is filled close in time with extremely soft silicone and fully vulcanized together or they are filled and fully vulcanized in separate steps.

1. A method of manufacturing a breast prosthesis which comprises bodies welded in plastic films and approximating the shape of a breast, preferably made of a transparent, addition cross-linked two-component silicone rubber mass and an addition cross-linked two-component silicone rubber mass having an added hollow sphere filler largely impermeable to light, the method comprising the following steps:
welding a film pouch of at least three film layers to produce at least two chambers;
inserting the film pouch into a prosthesis shaping tool;
filling an outwardly disposed chamber with a transparent mass;
partially or completely curing the transparent mass to achieve sufficient shape stability for further production steps;
filling an inner chamber with a second mass, largely impermeable to light and filled with light fillers; and
inserting a first mold half with a shallow cavity defining an end contour to completely cross-link the masses located in the chambers at an increased temperature.

2. A method in accordance with claim 1 where the transparent mass is cross-linked at or above ambient temperature.

3. A method in accordance with claim 2 wherein the film pouch is welded to produce a third chamber, the method further comprising filling the third chamber either together with the outer layer in a layer thickness of preferably 2-10 mm in the same function as the outer layer; or filling the third chamber together with the inner chamber.

4. A method in accordance with claim 1, wherein a second mold half with a deep cavity is placed on the first mold half for the formation of the thin outer layer in the outwardly disposed chamber of the film pouch so that the layer thickness of the outer layer is defined by a gap between the mold halves.

5. A method in accordance with claim 1, wherein a second mold half having a cavity formed similar to a membrane is placed onto the first mold half for the forming of the thin outer layer in the outwardly disposed chamber of the film pouch so that the layer thickness of the outer layer is defined by a gap between the mold halves.

6. A method in accordance with claim 1, wherein pressure and/or vacuum is exerted onto the film pouch tensioned in the mold and comprising elastic material for the formation of the thin outer layer in the outwardly disposed chamber so that a contour of the desired cavity results.

7. A method in accordance with claim 3, wherein the film layers forming the film pouch comprise polyurethane.

8. A method in accordance with claim 7, wherein the polyurethane films have a thickness of 40 μm to 100 μm.

9. A method in accordance with claim 8, wherein the polyurethane films are welded by means of thermal welding.

10. A method in accordance with claim 8, wherein the polyurethane films are welded by means of RF welding.

11. A method in accordance with claim 8, wherein the polyurethane films are welded by means of laser welding.

12. A method in accordance with claim 8, wherein the mass filled in the first chamber of the film pouch comprises a silicone mixture which already cross-links sufficiently strongly at ambient temperature and is largely stable in shape after a few minutes reaction time.

13. A method in accordance with claim 12, wherein color pigments are mixed in to the mass filled in the first chamber of the film pouch.

14. A method in accordance with claim 13, wherein a softness of the silicone filled in the first chamber of the film pouch amounts to between 170 and 230 units measured in penetration units after the cross-linking.

15. A method in accordance with claim 14, wherein the increased temperature is selected for the complete cross-linking of the mass filled in the second chamber of the film pouch such that the film material is permanently plastically deformed without permanently damaging the film.

16. A method in accordance with claim 15, wherein the increased temperature is set to approx. 130° C. when polyurethane is used as the film material.

17. A method in accordance with claim 1, wherein the film pouch is produced from four film layers while forming three chambers, with a comparatively thin third chamber being arranged on a rear side of the breast prosthesis.

18. A method in accordance with claim 17, wherein the third chamber is filled together with the first outwardly disposed chamber.

19. A breast prosthesis in accordance with claim 18, wherein the first and/or third chambers each have a thickness of 2 to 10 mm.

20. A breast prosthesis in accordance with claim 19, wherein the third chamber has a thickness of 5 to 50 mm.

21. A method of manufacturing a breast prosthesis which comprises bodies welded in plastic films and approximating the shape of a breast, preferably made of a transparent, addition cross-linked two-component silicone rubber mass and an addition cross-linked two-component silicone rubber mass having an added hollow sphere filler largely impermeable to light, the method comprising the following steps:
welding a film pouch of at least three film layers to produce at least two chambers including an outwardly disposed and an inner chamber;
inserting the film pouch into a prosthesis shaping tool;
filling the outwardly disposed chamber with a first transparent mass already cross-linked at or above ambient temperature;
partially or completely curing the transparent mass to achieve sufficient shape stability for the following further production steps;
filling the inner chamber with a second mass, largely impermeable to light and filled with light fillers; and
inserting one mold half with a shallow cavity defining an end contour to completely cross-link the masses located in the chambers at an increased temperature, where an outer layer formed in the outwardly disposed chamber is thinner than a layer formed in the inner chamber.
